(19) United States
(12) Patent Application Publication
(10) Pub. No.: US 2025/0004870 A1
(43) Pub. Date: Jan. 2, 2025

(54) Log File Recommender

(71) Applicant: International Business Machines Corporation, Armonk, NY (US)

(72) Inventors: Nehal Dudani, Hamburg (DE); Dennis Butterstein, Stuttgart (DE); Tobias Kevin Fränzel, Tuebingen (DE); Alexander Merschel, Stuttgart (DE); Thomas Schwarz, Stuttgart (DE); Martin Anton Oberhofer, Sindelfingen (DE)

(21) Appl. No.: 18/344,368

(22) Filed: Jun. 29, 2023

(51) Int. Cl. G06F 11/07

(52) U.S. Cl. CPC G06F 11/0781; G06F 11/079

(57) ABSTRACT

A computer implemented method identifies a root cause of a problem. A number of processor units uses a machine learning model to predict a set of initial log files for review to identify the root cause of the problem. The number of processor units displays the set of initial log files predicted by the machine learning model on a graphical user interface. The number of processor units predicts a set of next log files for review to identify the root cause of the problem using the machine learning model and user behavior data related to the graphical user interface in response to a user input to the graphical user interface. The number of processor units displays a recommendation to review the set of next log files predicted by the machine learning model on the graphical user interface.

### BACKGROUND

The disclosure relates generally to an improved computer system and more specifically to recommending log files for review in response to an application or computer system issue.

Log files are tools used to troubleshoot application and computer issues. These log files provide insight into the behavior of an application by recording events, errors, warnings, and other information. Analysis of these log files can be performed to aid in identifying the root causes of issues and to identify actions to resolve those issues. Log files can be used for error identification, debugging, performance analysis, auditing compliance, and other purposes.

Often times, the analysis of log files performed to identify causes for problems and resolve reported problems involves multiple log files. Analysis of one log file can provide parameters or information that can be used to search for other log files that may be of interest for analysis in identifying the root cause of the problem. For example, analyzing one log file may reveal information that references other log files or components that can be connected to other components that generate log files. These log files for other components can sometimes be identified using the current log file. For example, a log file may include error messages or unique identifiers that can be used to search for other log files.

This type of information is not always present. In some cases, analysis of log files does not provide information that can be used to easily identify another log file for review. In this case, knowledge about the system, dependencies with other systems, and common issues between systems can be used to determine related log files for review. Further, past experience with similar issues can be used to determine which log files to review that can provide information about the current issue.

### SUMMARY

According to one illustrative embodiment, a computer implemented method identifies a root cause of a problem. A number of processor units uses a machine learning model to predict a set of initial log files for review to identify the root cause of the problem. The number of processor units displays the set of initial log files predicted by the machine learning model on a graphical user interface. The number of processor units predicts a set of next log files for review to identify the root cause of the problem using the machine learning model and user behavior data related to the graphical user interface in response to a user input to the graphical user interface. The number of processor units displays a recommendation to review the set of next log files predicted by the machine learning model on the graphical user interface. According to other illustrative embodiments, a computer system, and a computer program product for identifying a root cause of a problem are provided.

### BRIEF DESCRIPTION OF THE DRAWINGS

FIG. 1 is a block diagram of a computing environment in accordance with an illustrative embodiment;

FIG. 2 is a block diagram of a log analysis environment in accordance with an illustrative embodiment;

FIG. 3 is an illustration of training a machine learning model in accordance with an illustrative embodiment;

FIG. 4 is a flow diagram of a process for creating and using a machine learning model to recommend log files for review in accordance with an illustrative embodiment;

FIG. 5 is a graphical user interface for problem analysis in accordance with an illustrative embodiment;

FIG. 6 is a flowchart of a process for identifying a root cause of a problem in accordance with an illustrative embodiment;

FIG. 7 is a flowchart of a process for identifying a root cause of a problem in accordance with an illustrative embodiment;

FIG. 8 is a flowchart of a process for training a machine learning model in accordance with an illustrative embodiment;

FIG. 9 is a flowchart of a process for training a machine learning model in accordance with an illustrative embodiment;

FIG. 10 is a flowchart of a process for retraining a machine learning model in accordance with an illustrative embodiment; and

FIG. 11 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

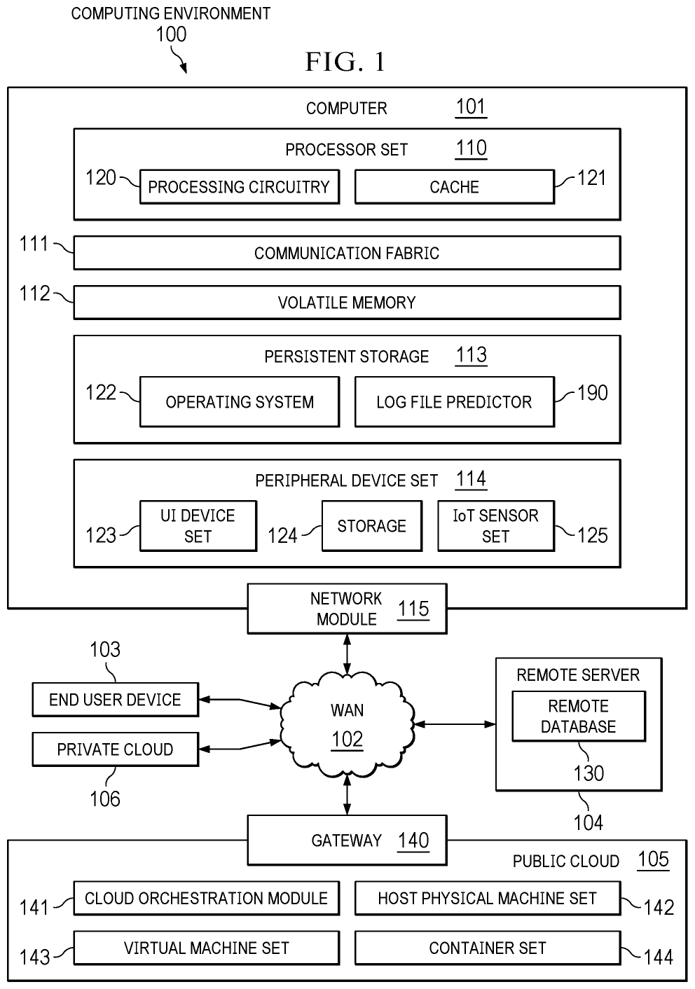

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as log file predictor 190. In this example, log file predictor 190 can make suggestions of log files to review to find the root cause to a problem. In addition to log file predictor 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and log file predictor 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in log file predictor 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in log file predictor 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. The illustrative embodiments recognize and take into account that a problem description can be received for an issue in a system and that a user identifies a log file to review based on the problem description. The selection of the log file is made from various log files that can be present within a computer system.

The computer system can have multiple hardware architectures and appointments. Further, different components and configurations are present in the computer system. These different components can generate log files. These different components include, for example, an operating system, a Web server, a database, an application server, a network device, a virtual platform, an application, a microservice, a security service, and other types of components that run in the computer system. With these different components, hundreds or thousands of log files may be present that are relevant to different problems.

Currently, subject matter experts (SMEs) use their experience to information in the computer system to determine a root cause of the problem. In other words, the subject matter experts can determine which log files to review based on their experience. Analyzing and navigating through the numerous log files requires many years of experience. Newer engineers can require extensive training time to be able analyze and navigate log files. When subject matter experts train newer engineers, their ability to have time to analyze and troubleshoot problems is limited.

Identifying log files to analyze can be complex. A common transaction ID to connect log entries between files components may not be present. Further, different components can have different file structures. Additionally, a file's relevance identifying the root cause for a particular problem can vary from case to case. The subject matter experts decide which files to check based on the analysis of a profile based on experience. A generally applicable process is not available with current log techniques for analyzing log files to troubleshoot problems.

Thus, illustrative embodiments provide a computer implemented method, apparatus, a computer system, and a computer program product for identifying a root cause of the problem. In one illustrative example, a computer implemented method is used to identify the root cause of a problem. A number of processor units uses a machine learning model to predict a set of initial log files for review to identify the root cause of the problem. The number of processor units displays the set of initial log files predicted by the machine learning model on a graphical user interface. The number of processor units predicts a set of next log files for review to identify the root cause of the problem using the machine learning model and user behavior data related to the graphical user interface in response to a user input to the graphical user interface. The number of processor units displays a recommendation to review the set of next log files predicted by the machine learning model on the graphical user interface.

As used herein, a “set of” when used with reference items means one or more items. For example, a set of initial log files is one or more of initial log files.

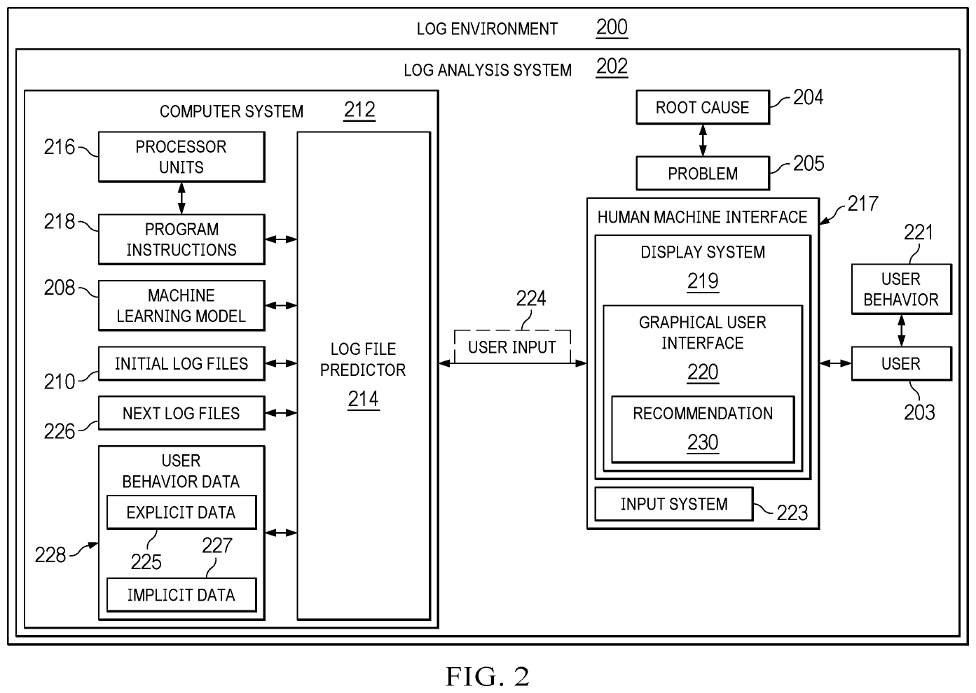

With reference now to FIG. 2, a block diagram of a log analysis environment is depicted in accordance with an illustrative embodiment. In this illustrative example, log environment 200 includes components that can be implemented in hardware such as the hardware shown in computing environment 100 in FIG. 1.

In this illustrative example, log analysis system 202 in log environment 200 can operate to assist user 203 in identifying root cause 204 of problem 205. Log analysis system 202 comprises computer system 212 and log file predictor 214. Log file predictor 214 is located in computer system 212.

Log file predictor 214 can be implemented in software, hardware, firmware, or a combination thereof. When software is used, the operations performed by log file predictor 214 can be implemented in program instructions configured to run on hardware, such as a processor unit. When firmware is used, the operations performed by log file predictor 214 can be implemented in program instructions and data and stored in persistent memory to run on a processor unit. When hardware is employed, the hardware can include circuits that operate to perform the operations in log file predictor 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different type of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, log file predictor 214 operates to assist user 203 in identifying root cause 204 for problem 205. Log file predictor 214 uses machine learning model 208 to predict a set of initial log files 210 for review to identify root cause 204 of problem 205.

Log file predictor 214 displays the set of initial log files 210 predicted by machine learning model 208 on graphical user interface 220. Other information can also be displayed on graphical user interface 220 in addition to the set of initial log files 210. For example, at least one of an input field for a search query, a search result, keywords highlighted from a search of a log file, a set of related customer cases, or a problem description for the problem can be displayed on graphical user interface 220.

In this illustrative example, user behavior 221 for user 203 with respect to graphical user interface 220 can be identified from the display of this information on graphical user interface 220. This user behavior identified from interaction or viewing graphical user interface 220 forms user behavior data 228.

In this illustrative example, graphical user interface 220 is displayed on display system 219 in human machine interface (HMI) 217. Human machine interface 217 also includes input system 223. Display system 219 is a physical hardware system and includes one or more display devices on which graphical user interface 220 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

User 203 is a person that can interact with graphical user interface 220 through user input 224 generated by input system 223 for computer system 212. Input system 223 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device.

Log file predictor 214 predicts a set of next log files 226 for review to identify root cause 204 of problem 205 using machine learning model 208 and user behavior data 228 related to graphical user interface 220 in response to a user input 224 to graphical user interface 220. Machine learning model 208 takes a number of different forms. For example, machine learning model 208 can be selected in a group comprising a transformer machine learning model, a Bidirectional Encoder Representations from Transformers (BERT) machine learning model, a neural network work, a recurrent neural network, and other suitable types of machine learning models.

In this illustrative example, user behavior data 228 can be at least one of explicit data 225 or implicit data 227. Explicit data 225 can be data based on user behavior 221 that generates user input 224. For example, explicit data can be a selection of a log file, a rejection of the log file, or other suitable user input with respect to log files. Implicit data 227 can be based on information displayed or presented to the user on graphical user interface 220. For example, implicit data 227 can be in the form of keywords and log files in graphical user interface 220. Implicit data 227 can also be based on user input 224 in some examples. For example, implicit data 227 can comprise searches performed by user 203 in graphical user interface 220. In the illustrative example, user behavior data 228 can be selected from at least one of explicit data 225, implicit data 227, sequences of log files viewed by a user, a selection of a log file for review, the removal of a log file for consideration, a search query, a set of keywords displayed on the graphical user interface, a portion of the log file reviewed, an amount of time spent on a log file, or other behavior by user 203 with respect to graphical user interface 220.

In this example, log file predictor 214 displays recommendation 230 to review the set of next log files 226 predicted by machine learning model 208 on graphical user interface 220. Initially in one illustrative example, the sequences of log files viewed by user 203 are zero or no log files. In other words, a log file has not yet been recommended because user 203 has not selected a log file.

Log predictor file 214 can use machine learning model 208 to predict and display a set of initial log files 210. This display of the set of initial files 226 can be made to provide a starting point to provide log files that may be selected for review.

In this illustrative example, user behavior 221 may be to select one of the set of initial log files or to select a different log file. The different log file can be obtained from a search or other source. As user 203 selects log files for review, those log files are added to the sequence of log files that are input with other user behavior data 228 to determine the next log file to recommend based on selection.

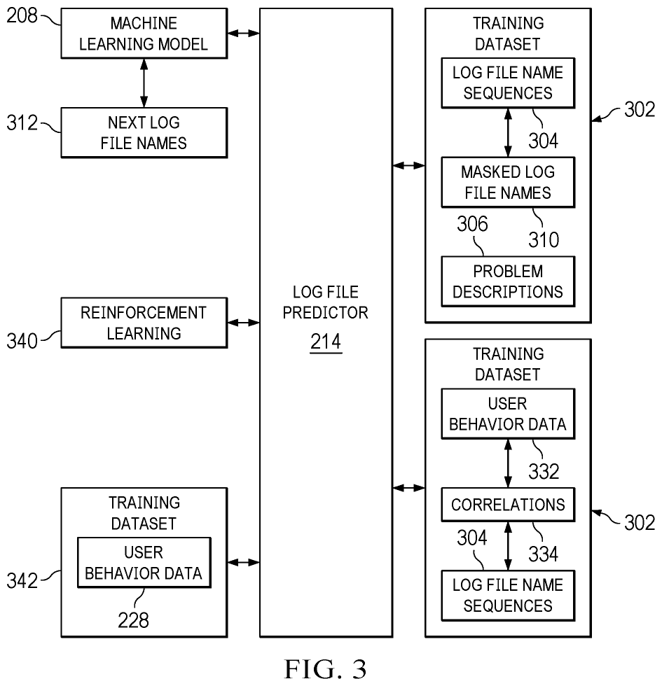

Turning next to FIG. 3, an illustration of training a machine learning model is depicted in accordance with an illustrative embodiment. In the illustrative examples, the same reference numeral may be used in more than one figure. This reuse of a reference numeral in different figures represents the same element in the different figures.

In this illustrative example, log file predictor 214 trains machine learning model 208 to predict the set of initial log files 210 and the set of next log files 226 to create trained machine learning model 300 using training dataset 302. The initial set of log files 210 are predicted using the problem description.

In this illustrative example, the training can be performed using training dataset 302. Training dataset 302 comprises log file name sequences 304 used in determining root cause 204 of problem 205 and problem descriptions 306 for problem 305.

In this example, a log file name sequence in log file name sequences 304 is a sequence of log filenames in in the order that the log files were reviewed or analyzed to determine root cause 204 of problem 205 for a particular problem description and problem descriptions 306. Log file name sequences 304 can be historical sequences of long filenames followed by users such as subject matter experts used to determine root cause 204 for problem 205. In other words, the same type of problem may be analyzed by multiple subject matter experts for the same type of problem 205. These log file name sequences and their problem descriptions are used to create training dataset 302.

A problem description can be, for example, “the replication engine has stopped working in the database”. Another problem description can be “incorrect data replicated in the tables”.

In one illustrative example, this training of machine learning model 208 can be performed in multiple stages or phases. Further, log file predictor 214 can start training with a pretrained version of machine learning model 208.

Log file predictor 214 can train machine learning model 208 to predict masked log file names 310 in log file name sequences 304. In this example, a masked log file name in a log file name sequence is a log file name that is hidden. The masked log file name can be anywhere in the log file name sequence. Machine learning model 208 is trained to predict the name of the masked log file name based on the log file names in the other portions of the log file name sequence that are not masked. In these examples only a single log file name is masked in the log file name sequence.

In this example, log file predictor 214 trains machine learning model 208 to predict next log file names 312 in log file name sequences 304 in response to training machine learning model 208 to predict masked log file names 310 in the log file name sequences 304. In this example, this phase of training is performed using training dataset 302 comprising log file name sequences 304, user behavior data 332, and correlations 334 between the user behavior data 332 and log file name sequences 304. In this example, log file name sequences 304 is a type of user behavior data and can be correlated to other user behavior data in user behavior data 332.

Additionally, after using machine learning model 208 to predict the next log file names 312 in response to user behavior 221, additional training of machine learning model 208 can be performed based on user behavior data 228 collected for user behavior 221. For example, log file predictor 214 can retrain machine learning model 208 using reinforcement learning 340 and training dataset 342 comprising user behavior data 228 relating to user behavior 221 with respect to graphical user interface 220.

In one illustrative example, one or more solutions are present that overcome a problem with determining the root cause of the problem. As a result, one or more solutions can provide an ability to more quickly and efficiently determine the root cause of the problem. With the use of log analysis system 202 in the different illustrative examples, less experienced users than subject matter experts can perform root cause analysis more efficiently even with less experience.

In the illustrative examples, a log analysis system 202 with graphical user interface 220 provides a tool to users to identify a sequence of log files to review in determining the root cause of the problem. In the illustrative examples, this prediction of the next file in the sequence of log files is based on user behavior data that includes both explicit data and implicit data. In this manner, problem resolution can be accelerated using this system.

Computer system 212 can be configured to perform at least one of the steps, operations, or actions described in the different illustrative examples using software, hardware, firmware, or a combination thereof. As a result, computer system 212 operates as a special purpose computer system in which log file predictor 214 in computer system 212 enables predicting a next log file to review in determining root cause 204 of problem 205. Log file predictor 214 transforms computer system 212 into a special purpose computer system as compared to currently available general computer systems that do not have log file predictor 214.

In the illustrative example, the use of log file predictor 214 in computer system 212 integrates processes into a practical application for a method identifying a root cause of the problem in a computer system such as computer system 212. In one illustrative example, log file predictor 214 in computer system 212 is directed to a practical application of processes integrated into log file predictor 214 in computer system 212 that suggests log files for review in identifying the root cause of the problem. In this illustrative example, log file predictor 214 in computer system 212 uses a machine learning model to predict a set of initial files based on the problem description of the problem. Additionally, log file predictor 214 recommends a next log file for review based on user behavior such as the selection of a log file review.

Further, although the illustrative examples of focused on describing training with respect to names of log files and user behavior data, other information can also be used in training machine learning model 208 to predict the next log file for review based on the sequence of log files already reviewed. For example, the content of the log files can also be included in the training datasets used to train machine learning model 208. In other words, the log entries in the log files can be used to train machine learning model 208 in addition to log file name sequences and user behavior data.

The illustration of log environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more users in addition to user 203 can review log files in analyzing problems using human machine interfaces in addition to human machine interface 217. As another example, machine learning model 208 is trained for a specific application in this example. For example, the application can be a database, a backend database, a data replication engine, high-availability service, and other applications that can generate or use logs. One or more machine learning models in addition to machine learning model 208 can be trained to predict the next log file from sequences of log files for other types of patterns. Further, machine learning model 208 can be trained for an application in a specific domain. Each domain is a specific environment such as a software development, production, testing, cloud, and other types of environments.

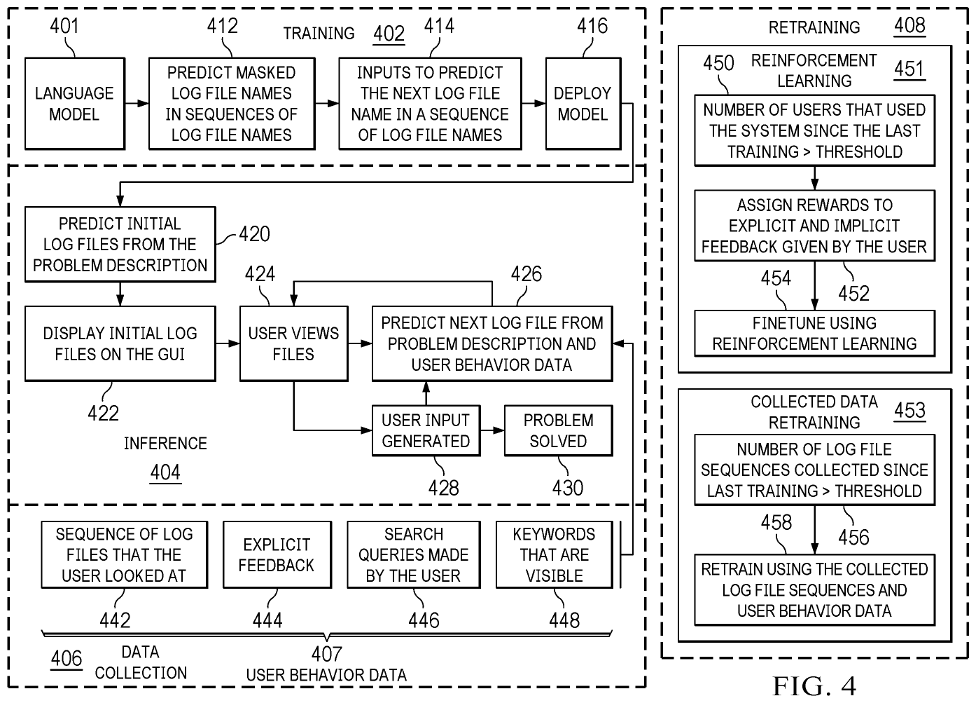

With reference next to FIG. 4, a flow diagram of a process for creating and using a machine learning model to recommend log files for review is depicted in accordance with an illustrative embodiment. In this illustrative example, flow diagram 400 can be implemented in log analysis system 202 in FIG. 2. As depicted, data flow 400 has four sections. These sections are training 402, inference 404, data collection 406, and retraining 408.

As depicted, training 402 begins with language model 401 being trained to predict masked log file names in sequences of log file names in block 412. In this block, this training is considered a fine-tuning of language model 401. In this example, language model 401 is a type of machine learning model that is designed to understand human language.

In this example, this language model can be pretrained to understand human language prior to training in block 412. For example, language model 401 can be trained on a database of text and learn statistical patterns and structures in language. Pretraining can be performed to teach language model 401 to predict missing words in sentences. This type of training enables the machine learning model to learn basic concepts of natural language such as which words tend to appear together. This pretrained model can also be referred to as a foundation model.

This pretrained model can then be further trained to perform a specific task. In this example, the specific task is predicting a next log file from a sequence of log files and a problem description.

Additional training is performed in block 414 in which language model 401 is trained to use additional inputs to predict the next log file name in a sequence of log file names. In block 414, the training is considered a second fine-tuning of language model 401. This fine-tuning can also be referred to as conditioning of language model 401.

In block 414, the additional inputs are user behavior data that can be collected from monitoring user behavior with respect to a graphical user interface. The prediction of the next file name in a sequence of filenames can be performed from a given set of filenames. This type of prediction involves multiclass classification. Language model 401 is then deployed for use in block 416.

In block 416, language model 401 can predict a set of initial log files for review based on a problem description. In other words, language model 401 predicts the set of log file names corresponding to log files as recommendations for review.

Further, language model 401 can predict a next log file to recommend for review based on the current sequence of log files reviewed by user. In other words, the current sequence of log files reviewed by the user is input into language model 401. In turn, language model 401 outputs a prediction of the next log file that should be reviewed based on the sequence of log files input into language model 401.

Next in inference 404, the machine learning model is used to analyze a problem to determine a root cause. In inference 404, a set of initial log files is predicted from a problem description input into language model 401 in block 420. The initial log files are displayed on a graphical user interface in block 422. In this example, the user views the files displayed on the graphical user interface in block 424.

User input is generated in block 428. This user input can be a selection of one of the initial log files displayed in block 422, a log file selected from a search, a recommended log file, or other types of user input with respect to log files.

A next log file is predicted in response to the user input from the problem description and user behavior data in block 426. This prediction can be made using user behavior data 407 collected through data collection in block 406. In this example, the user behavior data 407 is collected in data collection by in block 406 in flow diagram 400. User behavior data 407 can be explicit or implicit data.

Explicit data can be based on user input with respect to log files. This user input can be the selection of an initial log file, a selection of the recommended log file, or the selection of a log file from a search. This explicit user input can also be the deletion or clearing of a log file displayed in the graphical user interface.

In this example, implicit data can be other data based on information displayed to the user in the graphical user interface. For example, the display of information in the graphical user interface is considered implicit feedback because this display of information does not allow a direct conclusion as to whether the user found the recommended log file helpful.

In one example, the collected data in data collection 406 includes the sequence of log files that the user has looked at 442, explicit feedback 444, search queries made by the user 446, and keywords that are visible 448. Other information can also be used in addition to these examples. The other information used to make this prediction includes other behavior data relating to user behavior with respect to the graphical user interface.

In one illustrative example, a user input selecting a log file for review can be generated in block 428. In response to selecting a log file, the next log file is predicted using the problem description and user behavior data 407 collected in data collection 406. This flow continues until the problem is solved with the process. The flow then ends with problem solved in block 430. In this illustrative example, a next log file can be predicted for review if a log file is not selected for review in the user input. Other user input such as scrolling through information displayed on graphical user interface can also be used to predict the next log file for review.

In data collection 406, different types of behavior data are collected for use in predicting the next log file name and for use in training the language model 401. In this section, the data collected can include sequence of log files that the user looked at 442 on the graphical user interface, explicit feedback 444, search queries made by the user 446, keywords that are visible 448 in the graphical user interface, and other types of data that can be collected with respect to user behavior with respect to the graphical user interface that the user interacts with when analyzing the problem.

In this example, sequence of log files that the user looked at 442 in behavioral data 407 are log files that the user has selected to review. These log files can include one or more of the initial log files, log files recommended to user, and log files from searches. Explicit feedback 444 can be user input selecting files such as initial log files, a recommended next log file, a log file from a search, or other log files that can be selected for review in the graphical user interface. Explicit feedback 444 can also be user input that removes or clears a log file from consideration.

Search queries made by the user 446 in behavioral data 407 includes are searches made by a user to search for log files for information to determine the root cause of the problem. Keywords that are visible 448 can be, for example, keywords in search results returned from queries and keywords in portions of log files displayed in graphical user interface.

Further training of language model 401 is performed in retraining 408. The additional training in retraining 408 can be performed in a number of different ways. In this example, retraining 408 includes reinforcement learning 451 and collected data retraining 453. Reinforcement learning 451 can be used to improve predictions based on user feedback collected in user behavior data 407. Collected data retraining 453 can be used to reduce issues of data drift. Data drift can occur with version upgrades of components in the application. Further, this type of training can also improve coverage. Initially collected data may not have as many cases as needed or desired level of accuracy. Further, this retraining can improve the overall performance of machine learning models in the form of language models.

For example, the reinforcement learning 451 can be initiated in block 450 if the amount of feedback collected from users using the machine learning model since the last retraining is greater than a threshold. Factors for selecting the threshold can include the overhead or cost of frequent retraining and redeployment of the model versus the improvement in predictions occurring from the retraining.

For example, if the system is heavily used by many users producing large amounts of feedback, the threshold may be set to a higher value to reduce the cost of retraining. On the other hand, if the system is used infrequently by a small number of users, a lower threshold is selected to avoid waiting longer periods of time before retraining.

With reinforcement learning 451 in block 452, rewards are assigned to explicit and implicit feedback received from users of the system. Both positive and negative rewards can be assigned to user behavior data 407 collected in data collection 406.

For example, a positive reward can be assigned when a recommended log file is selected for review. A negative reward can be assigned when a recommended log file is not selected for review. In other words, the negative reward results from a user by taking the recommendation made for the next log file for review.

The language model is retrained using reinforcement learning in block 454. In this example, the training is performed using the user behavior along with any assignment of rewards. The reinforcement learning is a machine learning algorithm that can be formed in which the language model predicts log files for review in order to maximize the rewards.

In another illustrative example, further training of language model 401 can be performed using collected data retraining 453. This type of retraining can be initiated in response to the number of log file sequences collected since the last retraining is greater than a threshold in block 456. With this example, the retraining of language model 401 is performed in block 458 using log file sequences and user behavior data 407 collected in data collection 406 collected since the last retraining.

Illustration of flow diagram 400 in FIG. 4 is an example of one manner in which process and data flow can be implemented in log analysis system 202 in FIG. 2. This illustration is not meant to limit the manner in which log analysis system 202 can be implemented in other illustrative examples. For example, process flow 400 predicts the next log file in block 426. In other illustrative examples, a set of one or more next files can be predicted. With this example, more than one log file can be predicted and recommended to the user for review. With this example, more than one log file can be recommended when the probability of several log files are above the selected threshold for selecting the next log file that should be reviewed.

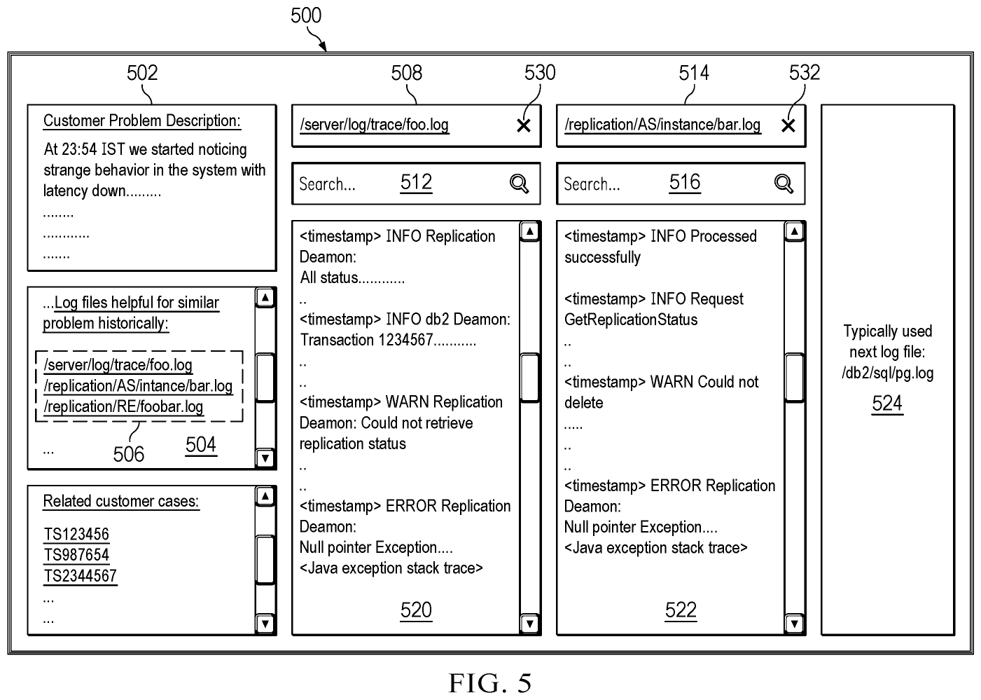

Turning now to FIG. 5, a graphical user interface for problem analysis is depicted in accordance with an illustrative embodiment. In this illustrative example, graphical user interface 500 is an example of an implementation graphical user interface 220 in FIG. 2.

In this illustrative example, graphical user interface 500 is displayed as a graphical tool for use by a user to identify a root cause of the problem. The arrangement and manner in which information is graphically displayed in graphical user interface 500 provides the user an ability to more easily and quickly identify and select log files for review in determining the root cause of the problem.

In this example, graphical user interface 500 includes customer problem description section 502. The problem description submitted by a customer is displayed in this section of graphical user interface 500.

Initial log files section 504 is a section in which initial log files 506 are displayed as recommendations for review by the user. In this example, initial log files 506 in this section can be predicted based on the problem description in customer problem description section 502. Additionally, related customer cases section 503 includes links that can be selected to display particular customer cases. The selection of one of these links can be used to predict a next log file for recommendation. The selection of a customer case can be considered implicit feedback.

As depicted, log file field 508 displays a path to the log file displayed in log file section 520. A user can input a path to a file that the user wants to view in log file field 508. Search field 512 can be used to search for content in the log file displayed in log file section 520. The results of this search are highlighting of keywords in the content displayed in log file section 520.

In this example, log file field 514 displays a path to the log file displayed in log file section 522. A user can input the path to the log file that the user wishes to view in log file field 514. The result of the input is the display of the log file in log file section 522. Search field 516 is used to search the contents of the log file displayed in log file section 522.

In this illustrative example, log entries are displayed in log file section 520 and log file section 522. In this example, two log files can be viewed at the same time in graphical user interface 500 in log file section 520 and log file section 522. These log files can be scrolled side-by-side in this example. In other illustrative examples, these log file sections can be scrolled in parallel horizontally in which one log file is shown over another log file in graphical user interface 500.

Next log file section 524 includes a next recommended log file for a user to review. This next log file is predicted based on user behavior with respect to graphical user interface 500. The user behavior can include a sequence of log files already reviewed by the user using graphical user interface 500. If the user has not yet reviewed log files, the behavior can include the interaction of user with respect to various fields in graphical user interface 500.

Further, user behavior can implicitly be the content viewed by the user or keywords seen by the user in graphical user interface 500. A user can be considered to have viewed content or seen keywords if the content or keywords are visible in graphical user interface 500. The content or keywords can be, for example, the log entries displayed in log file section 520 and in log file section 522. Keywords can be, for example, “error”, “null pointer exception”, “replication”, or other keywords that may be relevant to a particular problem.

Other user behavior that can be used to predict the next log file to recommend to the user include whether the user selects or inputs a log file for review or if the user clears or deletes a selection. For example, user input can be an input of a path to a log file in log file field 508. In another example, the path to the log file in log file field 508 can be cleared through the selection of delete control 530. Clearing or deleting the path in log file field 508 results in the log file being displayed in log file section 520 being cleared.

In a similar fashion, a path to a log file in log file field 514 can be cleared through the selection of delete control 532 in log file field 514. Clearing the path in log file field 514 results in the content of the log file being displayed in log file section 522 being cleared. This type of user input is also collected as user behavior data and can be used with a sequence of log files reviewed by the user so far to predict the next log file or recommendation for review.

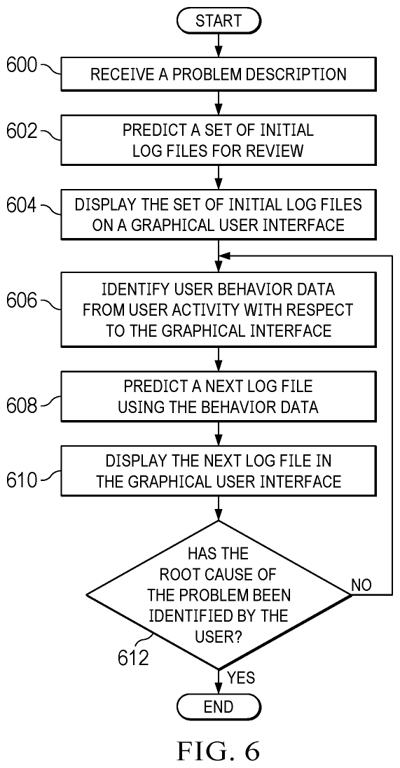

Turning to FIG. 6, a flowchart of a process for identifying a root cause of a problem is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in log file predictor 214 in computer system 212 in FIG. 2.

The process begins by receiving a problem description (step 600). The process predicts a set of initial log files for review (step 602). The process displays the set of initial log files on a graphical user interface (step 604).

The process identifies user behavior data from user activity with respect to the graphical interface (step 606). In step 606, the user behavior data can be, for example, explicit feedback, implicit feedback, a sequence of log files that the user has looked at, search queries made by the user, keywords that are visible on the graphical user interface, and other types of user behavior. In this example, keywords that are visible in the graphical user interface are a form of implicit feedback regarding user behavior. The visibility of keywords can influence selections made by the user and is an implicit type of feedback in this example. Explicit feedback can be the selection of a log file for review or affirmatively removing a log file from consideration.

The process predicts a next log file using the behavior data (step 608). This prediction can be made regardless of whether the user has selected a log file for review. Other user input such as performing search, scrolling through log files already displayed, or other user actions can be used to identify user behavior data that can be used to predict the next log file. In other words, the user input does not need to be the selection of another log file to determine the next log file for review. In predicting the next log file to review, the same log file may be recommended based on the user behavior data when a log file is not selected for review by the user.

The process displays the next log file in the graphical user interface (step 610). Depending on the type of user input, the next log file may be the same log file as previously predicted.

A determination is made as to whether the root cause of the problem has been identified by the user (step 612). If the root cause of the problem has been identified, the process terminates. Otherwise, the process returns step 606.

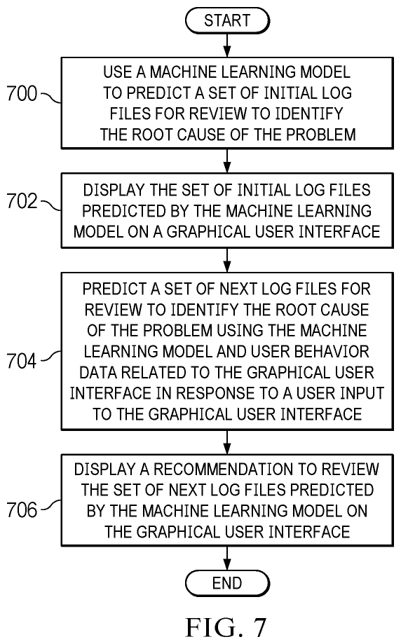

Turning next to FIG. 7, a flowchart of a process for identifying a root cause of a problem is depicted in accordance with an illustrative embodiment. The process in FIG. 7 can be implemented in hardware, software, or both. When implemented in software, the process can take the form of program instructions that are run by one or more processor units located in one or more hardware devices in one or more computer systems. For example, the process can be implemented in log file predictor 214 in computer system 212 in FIG. 2.

The process begins by using a machine learning model to predict a set of initial log files for review to identify the root cause of the problem (step 700). In step 700, the machine learning model is trained to predict the set of initial log files based on the problem description. In this example, the set of initial log files is one or more log files.

Further the process displays the set of initial log files predicted by the machine learning model on a graphical user interface (step 702). In step 702, other information can be displayed in addition to the set of initial log files in the graphical user interface. For example, at least one of an input field for a search query, a search result, keywords highlighted from a search of a log file, a set of related customer cases, or a problem description for the problem can be displayed on the graphical user interface.

The process predicts a set of next log files for review to identify the root cause of the problem using the machine learning model and user behavior data related to the graphical user interface in response to a user input to the graphical user interface (step 704). In step 704, the set of files is one or more log files. In some cases, the prediction of log file names may result in more than one log file name having a sufficiently high probability of being the correct log file to review in determining the root cause of the problem. In this example, the user input initiates a collection of user behavior data. The user input itself can also be user behavior data. For example, the user input can be to selection of a log file, remove, clear, or delete log file displayed in the graphical user interface, perform a search, or other types of user inputs. Further, the user input can be a user action with contents of a file such as keywords or scrolling to other portions of the file.

The process displays a recommendation to review the set of next log files predicted by the machine learning model on the graphical user interface (step 706). The process terminates thereafter.

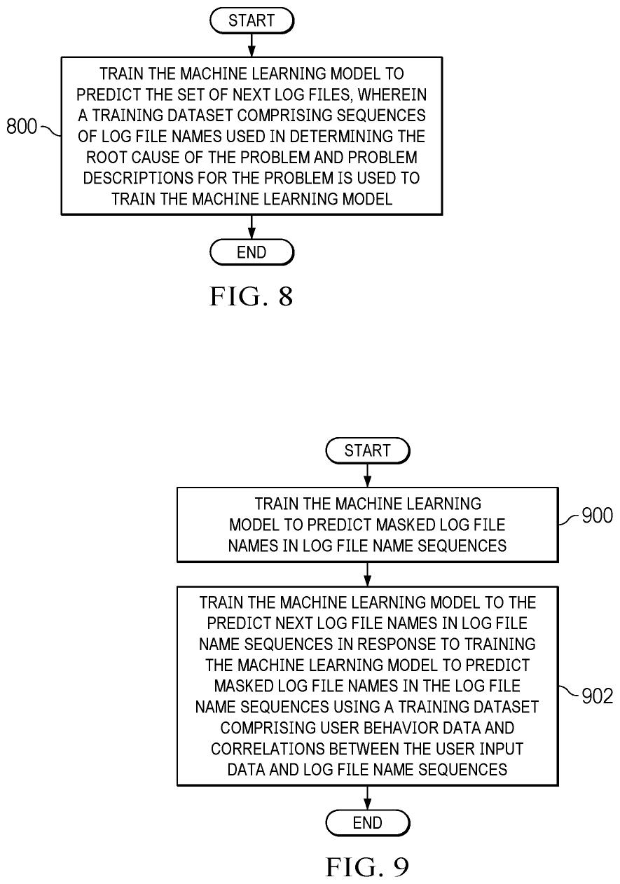

With reference now to FIG. 8, a flowchart of a process for training a machine learning model is depicted in accordance with an illustrative embodiment. The process in FIG. 8 can be implemented in hardware, software, or both. When implemented in software, the process can take the form of program instructions that are run by one of more processor units located in one or more hardware devices in one or more computer systems. For example, the process can be implemented in log file predictor 214 in computer system 212 in FIG. 3. In this example, the machine learning model can be a transformer machine learning model such as a Bidirectional Encoder Representations from Transformers (BERT) machine learning model.

The process trains the machine learning model to predict the set of next log files, wherein a training dataset comprising sequences of log file names used in determining the root cause of the problem and problem descriptions for the problem is used to train the machine learning model (step 800). The process terminates thereafter.

In FIG. 9, a flowchart of a process for training a machine learning model is depicted in accordance with an illustrative embodiment. The process in FIG. 9 is an example of an implementation for step 800 in FIG. 8.

The process trains the machine learning model to predict masked log file names in log file name sequences (step 900). In step 900, a masked log file name in a log file name sequence is a log file name that is hidden.

The process trains the machine learning model to the predict next log file names in log file name sequences in response to training the machine learning model to predict masked log file names in the log file name sequences using a training dataset comprising user behavior data and correlations between the user input data and log file name sequences (step 902). The process terminates thereafter.

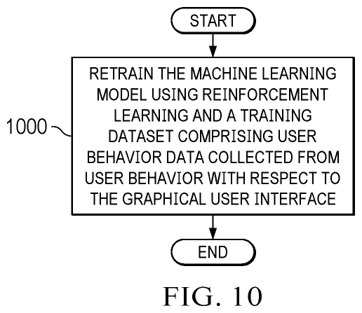

With reference to FIG. 10, a flowchart of a process for retraining a machine learning model is depicted in accordance with an illustrative embodiment. The process in this figure is an example of an additional step that can be performed in steps in FIG. 9. This step can be performed after the initial training of the machine learning model.

The process retrains the machine learning model using reinforcement learning and a training dataset comprising user behavior data collected from user behavior with respect to the graphical user interface (step 1000). The process terminates thereafter. In step 1000, the retraining can be used to collect log file sequences and user behavior data. The retraining can also be performed using reinforcement learning.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

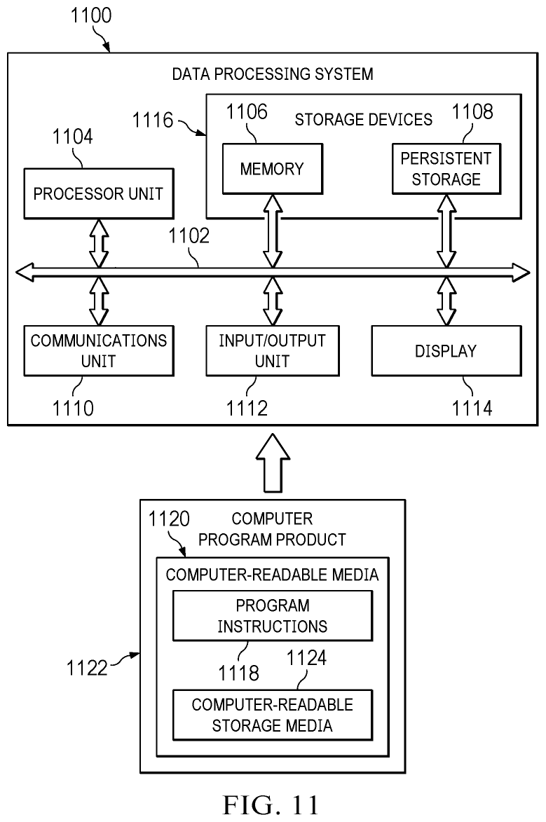

Turning now to FIG. 11, a block diagram of a data processing system is depicted in accordance with an illustrative embodiment. Data processing system 1100 can be used to implement computers and computing devices in computing environment 100 in FIG. 1. Data processing system 1100 can also be used to implement computer system 212 in FIG. 2. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1116 may also be referred to as computer readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program instructions, computer usable program instructions, or computer readable program instructions that can be read and executed by a processor in processor unit 1104. The program instructions in the different embodiments can be embodied on different physical or computer readable storage media, such as memory 1106 or persistent storage 1108.

Program instructions 1118 are located in a functional form on computer readable media 1120 that is selectively removable and can be loaded onto or transferred to data processing system 1100 for execution by processor unit 1104. Program instructions 1118 and computer readable media 1120 form computer program product 1122 in these illustrative examples. In the illustrative example, computer readable media 1120 is computer readable storage media 1124.

Computer readable storage media 1124 is a physical or tangible storage device used to store program instructions 1118 rather than a medium that propagates or transmits program instructions 1118. Computer readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer readable signal media. The computer readable signal media are signals and can be, for example, a propagated data signal containing program instructions 1118. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1120” can be singular or plural. For example, program instructions 1118 can be located in computer readable media 1120 in the form of a single storage device or system. In another example, program instructions 1118 can be located in computer readable media 1120 that is distributed in multiple data processing systems. In other words, some instructions in program instructions 1118 can be located in one data processing system while other instructions in program instructions 1118 can be located in one data processing system. For example, a portion of program instructions 1118 can be located in computer readable media 1120 in a server computer while another portion of program instructions 1118 can be located in computer readable media 1120 located in a set of client computers.

The different components illustrated for data processing system 1100 are not meant to provide architectural limitations to the manner in which different embodiments can be implemented. In some illustrative examples, one or more of the components may be incorporated in or otherwise form a portion of, another component. For example, memory 1106, or portions thereof, may be incorporated in processor unit 1104 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments provide a computer implemented method, computer system, and computer program product for recommending a log file for review as part of process to find a root cause for a problem. In one illustrative example, a computer implemented method identifies a root cause of a problem. A number of processor units uses a machine learning model to predict a set of initial log files for review to identify the root cause of the problem. The number of processor units displays the set of initial log files predicted by the machine learning model on a graphical user interface. The number of processor units predicts a set of next log files for review to identify the root cause of the problem using the machine learning model and user behavior data related to the graphical user interface in response to a user input to the graphical user interface. The number of processor units displays a recommendation to review the set of next log files predicted by the machine learning model on the graphical user interface.

With the use of the log analysis system in the different illustrative examples, less experienced users than subject matter experts can perform root cause analysis more efficiently even with less experience. In the illustrative examples, a log analysis system with a graphical user interface provides a tool to users to identify a sequence of log files to review in determining the root cause of the problem. In the illustrative examples, this prediction of the next file in the sequence of log files is based on user behavior data that includes both explicit data and implicit data. In this manner, problem resolution can be accelerated using this system.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for identifying a root cause of a problem, the computer implemented method comprising:
using, by a number of processor units, a machine learning model to predict a set of initial log files for review to identify the root cause of the problem;
displaying, by the number of processor units, the set of initial log files predicted by the machine learning model on a graphical user interface;
predicting, by the number of processor units, a set of next log files for review to identify the root cause of the problem using the machine learning model and user behavior data related to the graphical user interface in response to a user input to the graphical user interface; and
displaying, by the number of processor units, a recommendation to review the set of next log files predicted by the machine learning model on the graphical user interface.

2. The computer implemented method of claim 1, wherein at least one of an input field for a search query, a search result, keywords highlighted from a search of a log file, a set of related customer cases, or a problem description for the problem are displayed on the graphical user interface.

3. The computer implemented method of claim 1 further comprising:
training, by the number of processor units, the machine learning model to predict the set of next log files, wherein a training dataset comprising sequences of log file names used in determining the root cause of the problem and problem descriptions for the problem is used to train the machine learning model.

4. The computer implemented method of claim 3, wherein training, by the number of processor units, the machine learning model to predict the set of next log file comprises:
training, by the number of processor units, the machine learning model to predict masked log file names in log file name sequences, wherein a masked log file name in a log file name sequences is a log file name that is hidden; and
training, by the number of processor units, the machine learning model to predict the next log file names in log file name sequences in response to training the machine learning model to predict masked log file names in the log file name sequences using a training dataset comprising the log file name sequences, user behavior data, and correlations between the log file name sequences and the user behavior data.

5. The computer implemented method of claim 4 further comprising:
retraining, by the number of processor units, the machine learning model using reinforcement learning and a training dataset comprising user behavior data collected from user behavior with respect to the graphical user interface.

6. The computer implemented method of claim 1, wherein the user behavior data is selected from at least one of explicit user data, implicit user data, sequences of log files viewed by a user, a selection of a log file for review, a search query, a set of keywords displayed on the graphical user interface, a portion of the log file reviewed, or an amount of time the log file was reviewed.

7. The computer implemented method of claim 1, wherein the machine learning model is selected from a group comprising a transformer machine learning model, a Bidirectional Encoder Representations from Transformers (BERT) machine learning model, a neural network work, and a recurrent neural network.

8. A computer system comprising:
a number of processor units, wherein the number of processor units executes program instructions to:
using a machine learning model to predict a set of initial log files for review to identify a root cause of a problem;
displaying the set of initial log files predicted by the machine learning model on a graphical user interface;
predict a set of next log files for review to identify the root cause of the problem using the machine learning model and user behavior data related to the graphical user interface in response to a user input to the graphical user interface; and
display a recommendation to review the set of next log files predicted by the machine learning model on the graphical user interface.

9. The computer system of claim 8, wherein at least one of an input field for a search query, a search result, keywords highlighted from a search of a log file, a set of related customer cases, or a problem description for the problem are displayed on the graphical user interface.

10. The computer system of claim 8, wherein the number of processor units further executes the program instructions to:
training, by the number of processor units, the machine learning model to predict the set of next log files, wherein a training dataset comprising sequences of log file names used in determining the root cause of the problem and problem descriptions for the problem is used to train the machine learning model.

11. The computer system of claim 10, wherein as part of training the machine learning model to predict the set of next log files, the number of processor units further executes the program instructions to:
training the machine learning model to predict masked log file names in log file name sequences, wherein a masked log file name in a log file name sequence is a log file name that is hidden; and
training the machine learning model to predict next log file names in log file name sequences in response to training the machine learning model to predict masked log file names in the log file name sequences using a training dataset comprising the log file name sequences, user behavior data, and correlations between the log file name sequences and the user behavior data.

12. The computer system of claim 11, wherein the number of processor units further executes the program instructions to:
retrain the machine learning model using reinforcement learning and a training dataset comprising user behavior data collected from user behavior with respect to the graphical user interface.

13. The computer system of claim 11, wherein the user behavior data is selected from at least one of explicit user data, implicit user data, sequences of log files viewed by a user, a selection of a log file for review, a search query, a set of keywords displayed on the graphical user interface, a portion of the log file reviewed, or an amount of time the log file was reviewed.

14. The computer system of claim 11, wherein the machine learning model is selected from a group comprising a transformer machine learning model, a Bidirectional Encoder Representations from Transformers (BERT) machine learning model, a neural network work, and a recurrent neural network.

15. A computer program product for identifying a root cause of a problem, the computer program product comprising a computer readable storage medium having program instructions embodied therewith, the program instructions executable by a computer system to cause the computer system to:
use a machine learning model to predict a set of initial log files for review to identify the root cause of the problem; display the set of initial log files predicted by the machine learning model on a graphical user interface;
predict a set of next log files for review to identify the root cause of the problem using the machine learning model and user behavior data related to the graphical user interface in response to a user input to the graphical user interface; and
display a recommendation to review the set of next log files predicted by the machine learning model on the graphical user interface.

16. The computer program product of claim 15, wherein at least one of an input field for a search query, a search result, a set of related customer cases, or a problem description for the problem are displayed on the graphical user interface.

17. The computer program product of claim 15, wherein the program instructions are further executable by the computer system to cause the computer system to:
train the machine learning model to predict the set of next log files, wherein a training dataset comprising sequences of log file names used in determining the root cause of the problem and problem descriptions for the problem is used to train the machine learning model.

18. The computer program product of claim 17, wherein as part of training the machine learning model to predict the set of next log files, the program instructions are further executable by the computer system to cause the computer system to:
train the machine learning model to predict masked log file names in log file name sequences, wherein a masked log file name in a log file name sequence is a log file name that is hidden; and
train the machine learning model to predict next log file names in log file name sequences in response to training the machine learning model to predict masked log file names in the log file name sequences using a training dataset comprising the log file name sequences, user behavior data, and correlations between the log file name sequences and the user behavior data.

19. The computer program product of claim 18, wherein the program instructions are further executable by the computer system to cause the computer system to:
retrain the machine learning model using reinforcement learning and a training dataset comprising user behavior data collected from user behavior with respect to the graphical user interface.

20. The computer program product of claim 15, wherein the user behavior data is selected from at least one of explicit user data, implicit user data, sequences of log files viewed by a user, a selection of a log file for review, a search query, a set of keywords displayed on the graphical user interface, a portion of the log file reviewed, or an amount of time the log file was reviewed.
